(19) United States
(12) Patent Application Publication
(10) Pub. No.: US 2012/0188617 A1
(43) Pub. Date: Jul. 26, 2012

(54) AUTOMATIC DOCUMENT FEEDER WITH CONTINUOUS TRANSPARENT PLATEN

(76) Inventor: Michael Johannes Klausbruckner, San Diego, CA (US)

(21) Appl. No.: 13/010,805

(22) Filed: Jan. 21, 2011

(51) Int. Cl. H04N 1/04

(52) U.S. Cl. 358/498

(57) ABSTRACT

A scanning apparatus comprising a scan assembly including a photosensor array for receiving light reflected from successive portions of an item and for converting the reflected light into electrical signals; a transparent platen formed of a single continuous transparent member including: a first surface for supporting an item to be scanned; a second surface disposed opposite the first surface and proximate the scan assembly; a first portion disposed proximate an edge of the transparent platen and corresponding to a parking position of the scan assembly; and a second portion corresponding to a moving region of the scan assembly; and an automatic document feeder for moving a document into contact with the first surface of the first portion of the transparent platen.

### FIELD OF THE INVENTION

The present invention relates to the automatic document feeder of a scanning apparatus, whether as a separate scanning apparatus or as part of a copier, multifunction printer, or other such apparatus.

### BACKGROUND OF THE INVENTION

Optical scanners operate by imaging an object (e.g. a document) with a light source, and sensing a resultant light signal with an optical sensor array (also called a photosensor array herein). Each optical sensor or photoreceptor in the array generates a data signal representative of the intensity of light impinged thereon for a corresponding portion of the imaged object. The data signals from the array sensors are then processed (typically digitized) and stored in a temporary memory such as a semiconductor memory or on a hard disk of a computer, for example, for subsequent manipulation and printing or display, such as on a computer monitor. The image of the scanned object is projected onto the photosensor array incrementally by use of a moving scan line. The moving scan line is produced either by moving the document with respect to a scan assembly, or by moving the scan assembly relative to the document. Either or both of these methods may be embodied in a flat bed scanner, multi-function printer, or any scanner having manual and automatic feed capabilities.

Various types of photosensor devices may be used in optical scanners. For example, a commonly used photosensor device is the charge coupled device (CCD). A CCD builds up an electrical charge in response to exposure to light. The size of the electrical charge build up is dependent on the intensity and the duration of the light exposure. In optical scanners, CCD cells are aligned in linear array. The length of the linear sensor array is typically somewhat less than the length or width of the document scanning region. Each photosensor of the CCD has a portion of a scan line image impinged thereon as the scan line sweeps across the scanned object. The charge built up in each of the pixels is measured and discharged at regular “sampling intervals.” In most modern optical scanners, the sampling intervals of the CCD arrays are fixed.

An image of a scan line portion of a document is projected onto the scanner's linear photosensor array by scanner optics. In such CCD scanners, the scanner optics include an imaging lens which typically reduces considerably the size of the projected image from its original size. The scanner optics provide good depth of field in a CCD scanner. However, because the photosensors are so small in the CCD device, a fairly strong light source such as a fluorescent lamp is needed to illuminate the scan line image region of the document in order to provide sufficient signal strength at each photosensor site.

A second type of scanner is the contact image sensor (CIS) scanner. A CIS scanner includes a contact image sensor having a length that is substantially equal to the width of the scanning region. The photosensors in a CIS are substantially the same size as the pixel resolution of the scanner. Because the photosensors in the CIS are so much larger than they are in a CCD, a lower power light source (such as one or more LED's) is sufficient to provide enough illumination in the scan line image region. The CIS has a short depth of field and is typically mounted beneath the transparent platen upon which the document is placed. One or more rollers in the CIS carriage are biased against the bottom of the transparent platen so that the CIS is always at substantially the same distance from the top of the transparent platen.

Photosensors in a CCD or CIS scanner photosensor array are aligned in a “cross” direction, i.e., a direction parallel to the longitudinal axis of the scan line image which is projected thereon. The direction perpendicular to the “cross” direction will be referred to herein as the “scan” direction (i.e., the direction of movement of a document or of the photosensor array for scanning of the image).

At any instant when an object is being scanned, each photosensor in the photosensor array has a corresponding area on the object which is being imaged thereon. This corresponding area on the scanned object is referred to herein as a pixel. An area on a scanned object corresponding to the entire extent of the photosensor array is referred to herein as a scan line. For descriptive purposes, a scanned object is considered to have a series of fixed adjacently positioned scan lines. Further, scanners are typically operated at a scan line sweep rate such that one scan line width is traversed during each sampling interval.

In addition, when working with cut sheet print media, a copying, scanning or multifunction printing apparatus can provide automatic document feed, as well as manual document placement capabilities. An automatic document feeder (ADF) mechanism is capable of automatically loading and unloading single sheets sequentially to a functional station where the apparatus performs an operation, e.g., sequentially scanning the fed document sheets for copying, faxing, displaying on a computer monitor, or the like. Following the operation, the ADF then off-loads a sheet and feeds the immediately following sheet of the document to the functional station. A sequential flow of sheets by the ADF and positioning without the necessity of manual handling reduces the time required to accomplish the complete functional operation. An ADF may be designed to scan single-sided originals or two-sided originals.

Each document fed into the ADF is conveyed to an automatic scanning region where the document is scanned by a photosensor array and then the document is conveyed to a point outside the ADF, such as a document output tray. During ADF operation, the photosensor array remains fixed at the automatic scanning region “reading” or scanning the image as the document is conveyed past the scanning point by the ADF. During manual scanning, the document lays flat on and covers a portion of the flat platen while the photosensor array is moved under the platen the length (or width) of the document to read or scan the document.

In conventional scanners or multifunction printers having an ADF, the scanning point or portion of the flat platen used to scan a document provided by the ADF is separate and distinct from the portion of the flat platen utilized to scan a document manually positioned on the platen. FIG. 1 shows a perspective view of a prior art multifunction printer 100 including a scanning apparatus 130, an ADF 180, and a printing apparatus 190, such as an inkjet printer. Multifunction printer 100 can do printing, scanning of documents, or copying of documents (i.e. printing plus scanning). ADF 180 includes an input tray 182 where documents for scanning or copying are stacked, output tray 184 for receiving scanned documents. The ADF document scan path 181 from input tray 182 to output tray is indicated as a dashed line.

As shown in FIG. 2 (similar to FIG. 1 but with the ADF 180 raised up), ADF 180 can be attached to scanning apparatus body 132 of scanning apparatus 130 by a hinge 112, so that the under side 111 of ADF 180 can function as a lid for scanning apparatus 130. The surface of scanning apparatus body 132 that is covered by under side 111 of ADF 180 when ADF 180 is closed includes a frame 136. Transparent platen 140 (typically a flat piece of glass) is inset within the frame 136. The front of scanning apparatus 130 is cut away in FIG. 2 in order to show movable scan assembly 150 below transparent platen 140. Scan assembly 150 includes a photosensor array 152 (such as a contact image sensor) extending the width of the transparent platen 140, and a light source 156 that illuminates a scan line of a document or other item (not shown) that is placed on top of transparent platen 140. A light guide and other optics (not shown) can also be included in scan assembly 150. Scan assembly 150 is moved back and forth along scanning guide 134 in scanning direction 135 across the length of transparent platen 140 in order to scan the document or other item, to receive reflected light from the item through the transparent platen 140 scan line by scan line and to convert the reflected light into electrical signals. A controller (not shown) converts the electrical signals into digitized data to form a digitized image of the item. Scanning guide 134 can be a round rail, a rack and pinion or other guiding member that can use the power of a motor (not shown) to provide a linear motion along the scanning direction 135. A separate ADF transparent platen 142 is provided for scanning documents being fed by ADF 180. ADF document scan path 181 below the under side 111 of ADF 180 is shown in FIG. 2. The document to be scanned is moved by a transporter such as rollers 186 down the down ramp 137, across the ADF transparent platen 142, up the up ramp 138 and toward the under side 111 through which it passes on its way to output tray 184. A pressing member 188 forces the document into contact with ADF transparent platen 142 for scanning by scan assembly 150, which is parked below ADF transparent platen 142 during ADF scanning. Up ramp 138 is required in a conventional ADF 180 adjacent ADF transparent platen 142 in order to move the document out of contact with the ADF transparent platen 142 after scanning so that the scanned document can be directed toward the output tray 184. Therefore in a conventional scanning apparatus having both a transparent platen 140 that holds a stationary object while scan assembly 150 moves to scan the object, as well as an ADF 180 for moving documents past a parked scan assembly 150, a spacer 139 including an up ramp 138 is provided between transparent platen 140 and ADF transparent platen 142. Such a spacer can be on the order of 2 cm wide and adds to the overall length of multifunction printer 100 along scanning direction 135.

Another prior art configuration (FIG. 12 of U.S. Pat. No. 7,050,204) of an ADF 33 is shown in the lateral cross-sectional view of FIG. 3. Original documents to be scanned are stacked in original feed tray 62 and fed by paper feed roller 70 toward separation roller 71, where they are separated by separation pad 72 for feeding one at a time. Convey rods 73 and 75 hold the document against large roller 74 as the large roller 74 moves the document past end detection sensor 79 through an opening 36 above platen glass 40. After scanning by a scan assembly (not shown), the document is guided by pickup unit 76 to discharge unit 77 and then is discharged onto discharge tray 63. Although details of the transporter for the document (e.g. large roller 74) are different from the example shown in FIGS. 1 and 2, the ADF 33 is similar to ADF 180. Documents are fed from an upper input tray (62 or 182) to a lower output tray (63 or 184). Book platen glass 41 in FIG. 3 is similar to transparent platen 140 of FIG. 2 for holding stationary objects for scanning, and pickup unit 76 (like up ramp 138 and spacer 139) is located between platen glass 40 for ADF 33 and book platen glass 41.

Another similarity between the prior art example of FIG. 3 and that of FIGS. 1-2 is that that the ADF document scan path 181 turns the document upside down from its orientation in the input tray (62 or 182) by the time the document reaches the ADF transparent platen region (40 or 142). Therefore documents to be scanned must be loaded scan-side-up in the input tray (62 or 182) for ADF scanning, but scan-side-down on the transparent platen 140 or book platen glass 41 for manual scanning. This difference in document loading orientation can be confusing to users.

What is needed is an ADF-equipped scanning apparatus or multifunction printer having a smaller overall length along the scanning direction. Additionally, what is needed is an ADF for a scanning apparatus or multifunction printer that does not require loading documents in an input tray in a different orientation than when loading documents directly on the transparent platen.

### SUMMARY OF THE INVENTION

The present invention is directed to overcoming one or more of the problems set forth above. Briefly summarized, according to one aspect of the invention, the invention resides in a scanning apparatus comprising a scan assembly including a photosensor array for receiving light reflected from successive portions of an item and for converting the reflected light into electrical signals; a transparent platen formed of a single continuous transparent member including: a first surface for supporting an item to be scanned; a second surface disposed opposite the first surface and proximate the scan assembly; a first portion disposed proximate an edge of the transparent platen and corresponding to a parking position of the scan assembly; and a second portion corresponding to a moving region of the scan assembly; and an automatic document feeder for moving a document into contact with the first surface of the first portion of the transparent platen.

In another embodiment, the invention resides in a multifunction printer including: a printing apparatus; and a scanning apparatus comprising: a scan assembly including a photosensor array for receiving light reflected from successive portions of an item and for converting the reflected light into electrical signals; a transparent platen formed of a single continuous transparent member including: a first surface for supporting an item to be scanned; a second surface disposed opposite the first surface and proximate the scan assembly; a first portion disposed proximate an edge of the transparent platen and corresponding to a parking position of the scan assembly; and a second portion corresponding to a moving region of the scan assembly; and an automatic document feeder for moving a document into contact with the first surface of the first portion of the transparent platen.

In yet another embodiment, the invention resides in a scanning apparatus comprising: a transparent platen including a first surface for supporting an item to be scanned and a second surface disposed opposite the first surface; a light source configured to emit light through the transparent platen to reflect off the item; a scan assembly disposed proximate the second surface of the transparent platen, the scan assembly including a photosensor array for receiving light reflected from successive portions of the item and for converting the reflected light into electrical signals; a controller for providing digitized data from the electrical signals to form a digitized image of the item; and an automatic document feeder including: an input tray for loading documents to be scanned; a transporter for moving a document into contact with a portion of the first surface of the transparent platen corresponding to a parking position of the scan assembly; and an output tray for receiving documents after scanning, wherein the input tray is disposed between the output tray and the transparent platen.

In another embodiment, the invention resides in a method of scanning a document on a scanning apparatus including: a transparent platen including a first surface for supporting an item to be scanned and a second surface disposed opposite the first surface; a light source; a scan assembly disposed proximate the second surface of the transparent platen, the scan assembly including a photosensor array; a controller; and an automatic document feeder including: an input tray; a transporter; and an output tray, wherein the input tray is disposed between the output tray and the transparent platen; wherein the method comprises the steps: a) loading a document onto a surface of the input tray with a side to be scanned facing the surface of the input tray; b) initiating a scan operation; c) moving the document using the transporter into contact with a portion of the first surface of the transparent platen corresponding to a parking position of the scan assembly; d) emitting light from the light source through the transparent platen to reflect off the document; e) receiving light reflected from a portion of the document in the photosensor array and converting the reflected light into electrical signals; f) sending the electrical signals to the controller for providing digitized data corresponding to the portion of the document; g) continuing to advance the document past the parking position of the scan assembly; h) repeating steps d) through g) until the entire document has been scanned; and i) advancing the document to the output tray.

### BRIEF DESCRIPTION OF THE DRAWINGS

FIG. 1 is a perspective view of a prior art multifunction printer having an automatic document feeder in the closed position;

FIG. 2 is a perspective view of the multifunction printer of FIG. 1 with the ADF in the open position;

FIG. 3 is a lateral cross-sectional view of an alternative prior art ADF;

FIG. 4 is a perspective view of a multifunction printer including a scanning apparatus according to an embodiment of the invention;

FIG. 5 is a perspective view of the multifunction printer of FIG. 4 with the ADF in the closed position;

FIG. 6 is a schematic diagram showing how the different parts of the multifunction printer are related to one another and to an external computer; and

FIG. 7 is a lateral cross-sectional view of an embodiment of the invention where the ADF is a duplexing ADF.

### DETAILED DESCRIPTION OF THE INVENTION

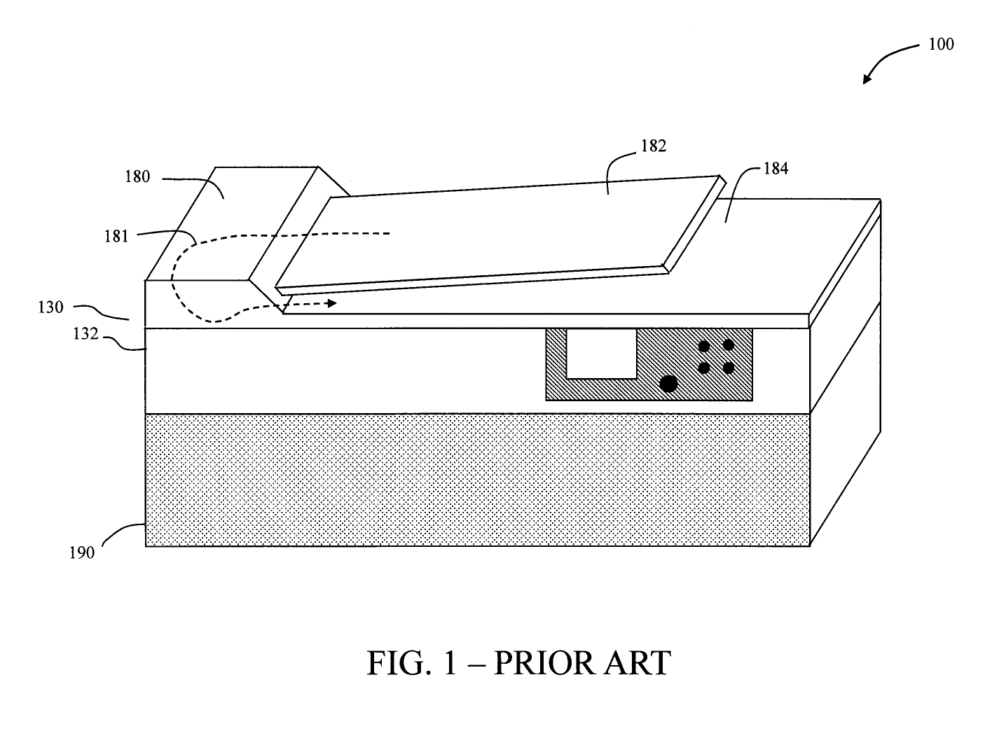

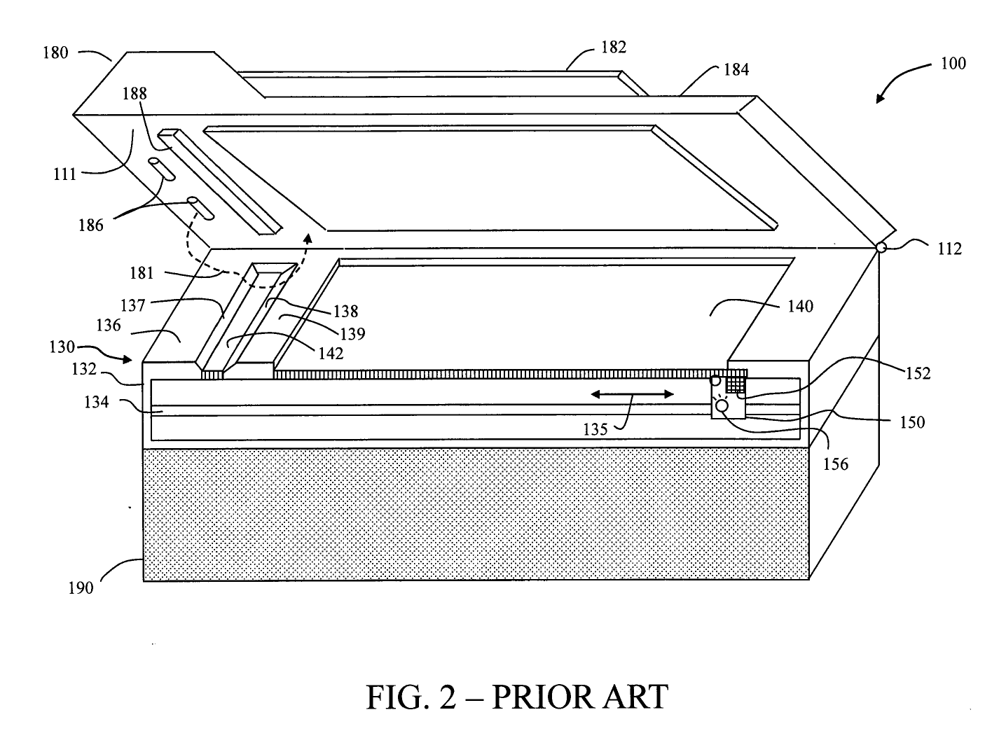

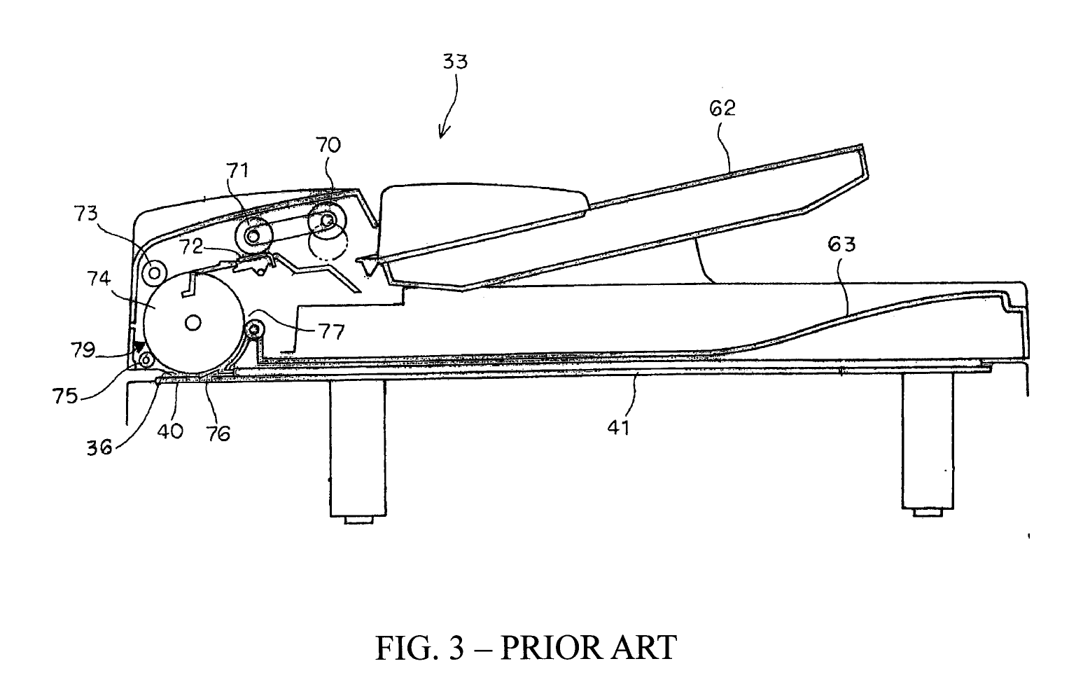

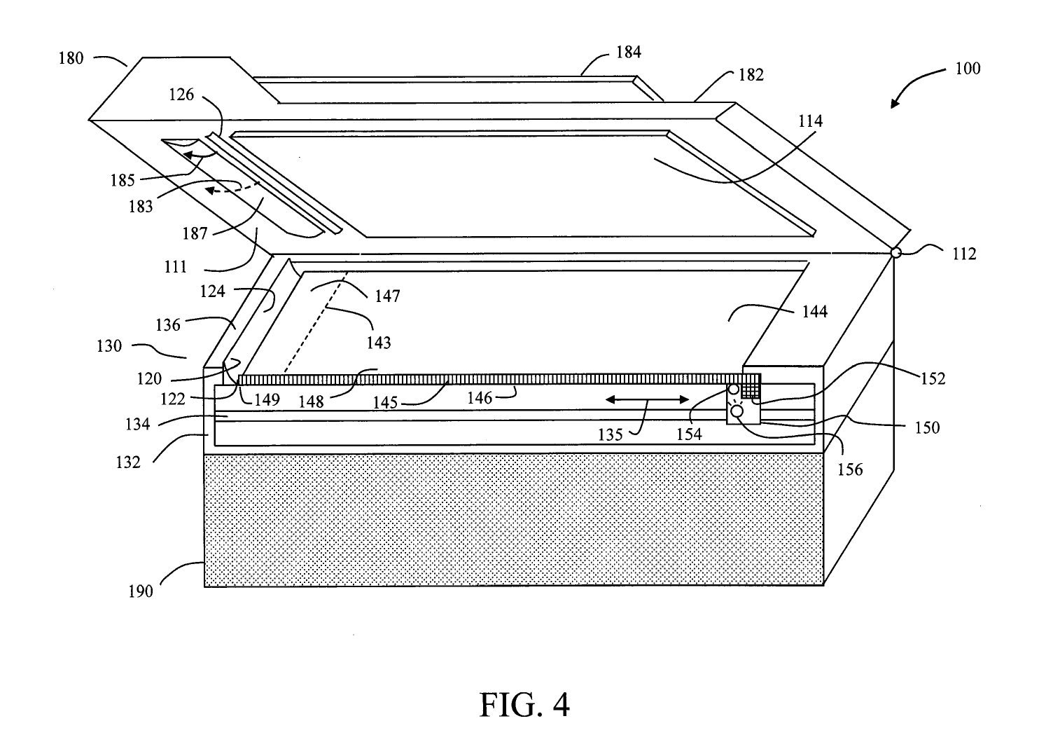

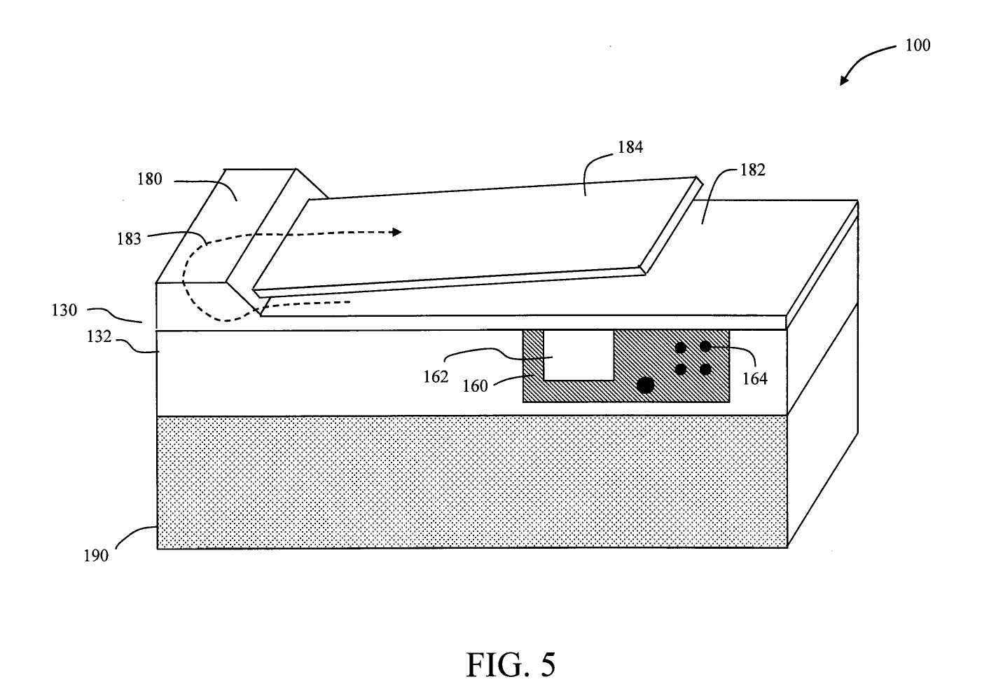

FIG. 4 shows a perspective view of a multifunction printer 100 according to an embodiment of the present invention. The ADF 180 is open, as in FIG. 2, in order to show that transparent platen 145 is a single continuous transparent member rather than a ADF transparent platen 142 separated by a spacer 139 or 76 from a transparent platen 140 for manual scanning as in the prior art (see FIG. 2 and FIG. 3). Also shown in FIGS. 4 and 5 is the ADF document scan path 183 corresponding to the present invention. Note that ADF document scan path 183 goes in the opposite direction than the prior art ADF document scan path 181 of FIGS. 1 and 2. In other words, at the under side 111 of the ADF 180, the document is moved in a direction from the transparent platen 145 toward the edge of the scanning apparatus 130, rather from the edge of the scanning apparatus 130 toward the transparent platen. Also notice that in this embodiment the input tray 182 is disposed between the output tray 184 and transparent platen 145 when the ADF 180 is closed, rather than the output tray 184 being disposed between the input tray 182 and the transparent platen 140 as in the prior art of FIGS. 1 and 2.

Although, in this embodiment, transparent platen 145 of scanning apparatus 130 is a single transparent member, it includes a first portion 147 located near an edge 149 (to the left of dashed line 143 in FIG. 4) that corresponds to a parking position of scan assembly 150 for ADF scanning, and an extended second portion 148 (to the right of dashed line 143) that corresponds to a moving region of scan assembly 150 for manual scanning of a stationary item placed on support surface 144. (It is understood that the scan assembly 150 needs to move across the region indicated by line 143 in order to reach the parking position for ADF scanning.) Transparent platen 145 includes a support surface 144 for supporting an item to be scanned, and an opposite surface 146 that is near scan assembly 150. For a CIS scanner, a wheel or other bearing surface 154 of scan assembly 150 is biased into contact with opposite surface 146 of transparent platen 145 in order to maintain a constant distance between the photosensor array 152 and the support surface 144 of the transparent platen 140. Light from light source 156 is transmitted through transparent platen 140, reflected from an item on support surface 144, and received by photosensor array 152 for conversion into electrical signals.

Under side 111 of ADF 180 includes different members in the regions corresponding to ADF scanning and manual scanning. In the manual scanning region corresponding to second portion 148 of transparent platen 145, a pressing plate 114 is affixed to under side 111. Pressing plate 114 can be compressible and/or it can be resiliently mounted on under side 111 so that when ADF 180 is lowered over an item to be manually scanned, the item is pressed against support surface 144 of transparent platen 145. Pressing plate 114 typically has a white surface to serve as an optical background and reference for scanning as scan assembly 150 is moved to scan the item. In the ADF scanning region corresponding to first portion 147 of transparent platen 145, under side 111 includes a transporter, such as a portion of a large roller 187 that is rotated in rotation direction 185 in order to move the document into contact with the support surface 144 of transparent platen 145 at the first portion 147 where scan assembly 150 is parked at a parking position for ADF scanning. Also in the example of FIG. 4, a document downward guide 126 is located between pressing plate 114 and large roller 187. As the document is fed from input tray 182 through a slot (not shown) in under side 111, document downward guide 126 directs the document down toward the support surface 144 of the transparent platen 140 and large roller 187 (or other transporter) moves the document across first portion 147 for scanning. Unlike the prior art, the ADF 180 of the embodiment of FIGS. 4 and 5 does not turn the document over before moving it across first portion 147 of transparent platen 145 for scanning. Thus documents are loaded in the input tray scan side down, similar to the orientation for loading for manual scanning.

After the document moves across first portion 147 of transparent platen 145 it needs to be lifted up and directed into a slot (not shown) in under side 111 for moving the document away from contact with the transparent platen 145 and onto output tray 184. In the example shown in FIG. 4, a document lifting surface 120 is incorporated into frame 136 of scanning apparatus 130 and is located near the edge 149 (and beyond edge 149) of transparent platen 145. Document lifting surface 120 has a similar function to up ramp 138 of the prior art shown in FIG. 2, as well as to pickup unit 76 of the prior art shown in FIG. 3. An important difference is that in the embodiment shown in FIG. 4, the transporter (large roller 187) is located between input tray 182 and document lifting surface 120. By contrast, in the prior art of FIG. 2, the up ramp 138 is located between the transporter (document feed rollers 186) and input tray 182. Also in the prior art of FIG. 3, pickup unit 76 is located between the transporter (large roller 74) and the input tray (original feed tray 62). The configuration of the embodiment shown in FIG. 4 where the document lifting surface 120 is beyond the edge of a single continuous transparent platen 145 allows reducing the length of the scanning apparatus 130 as seen by comparing FIG. 2 with FIG. 4.

Large roller 187 has a rotation direction 185 configured to move a document into contact with first portion 187 of the transparent platen 145 and then into contact with document lifting surface 120. In order not to present an edge of the document lifting surface 120 that the leading end of the document could catch on, a recessed portion 122 near the bottom of document lifting surface 120 is offset below the support surface 144 of transparent platen 145. In other words, recessed portion 122 is offset from support surface 144 of transparent platen 145 in a direction having a component that is along a direction from support surface 144 toward opposite surface 146. In order to guide the document away from support surface 144, a protruding portion 124 of document lifting surface 120 is above the transparent platen 145, i.e. it is offset from support surface 144 of transparent platen 145 in a direction having a component that is along a direction from opposite surface 146 toward support surface 144.

Many other details of the embodiment of FIGS. 4 and 5 are similar to the prior art multifunction printer of FIGS. 1 and 2 described above. In particular, ADF 180 can be attached to scanning apparatus body 132 of scanning apparatus 130 by a hinge 112, so that the under side 111 of ADF 180 can function as a lid for scanning apparatus 130. The surface of scanning apparatus body 132 that is covered by under side 111 of ADF 180 when ADF 180 is closed includes a frame 136. Transparent platen 145 (typically a flat piece of glass) is held within the frame 136. The front of scanning apparatus 130 is cut away in FIG. 4 in order to show movable scan assembly 150 below transparent platen 145. Scan assembly 150 includes a photosensor array 152 (such as a contact image sensor) extending the width of the transparent platen 145, and a light source 156 that illuminates a scan line of a document or other item (not shown) that is placed on top of transparent platen 145. A light guide and other optics (not shown) can also be included in scan assembly 150. Scan assembly 150 is moved back and forth along scanning guide 134 in scanning direction 135 across the length of transparent platen 145 in order to scan the document or other item, receiving reflected light from the item through the transparent platen 145 scan line by scan line and converting the reflected light into electrical signals. A controller (not shown) converts the electrical signals into digitized data to form a digitized image of the item. Scanning guide 134 can be a round rail, a rack and pinion or other guiding member that can use the power of a motor (not shown) to provide a linear motion along the scanning direction 135. The printing apparatus 190 can be an inkjet printer, for example.

Control panel 160 for the apparatus is shown in FIG. 5 as being located on the front of scanning apparatus 130. Control panel 160 can include display 162 and a variety of control buttons 164, which can include a Start button. For cases where display 162 is a touch screen, control buttons 164 can be integrated into the touch screen rather than being separate from it.

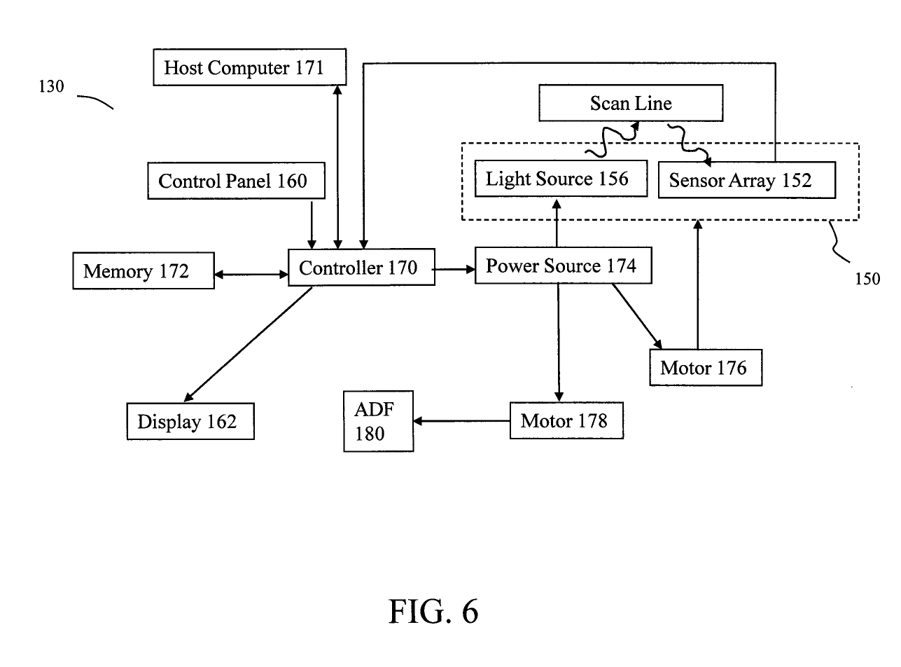

Whether scanning apparatus 130 is a separate unit or is incorporated into a multifunction printer or copier, scanning apparatus 130 will have a controller 170 including hardware and software or firmware. FIG. 6 schematically shows controller 170 and its relationship with other portions of scanning apparatus 130, printing apparatus 190 and associated computer. In normal scanning operation in the active mode of operation, a user can initiate a scanning operation from control panel 160, or alternatively a scanning job can be initiated from host computer 171 to which the scanning apparatus 130 or multifunction printer 100 is connected. In either case a signal is sent to controller 170, which then sends a signal to power source 174 to turn on light source 156 and also to operate motor 176 (in the case of manual scanning) in order to move sensor array module 150 along scanning direction 135. As sensor array module 150 is moved, light from light source 156 reflects off a document or other object that is placed on transparent platen 145, and impinges on photosensor array 152 one scan line at a time. A scan line electrical signal is sent from photosensor array 152 to controller 170 where the signals can be further processed before sending digitized data to memory 172 (or to host computer 171) in order to compose an entire digitized scanned image, scan line by scan line. When the scan is completed, controller 170 sends a signal to power source 174 to send power to motor 176 in order to return sensor array module 150 to its home position. Scanning with an ADF 180 is similar, except the controller sends a signal to power source 174 to operate motor 178 to power the ADF document transporter (such as the large roller 187 of FIG. 4) to move the documents over the transparent platen 145 as described above.

Having described the parts of the ADF and scanning apparatus, a method of scanning a document will be described with reference to FIGS. 4 and 6. One or more documents are loaded onto a surface of the input tray 182 with a side to be scanned facing the surface of the input tray 182. A scan operation is initiated at control panel 160 or at a host computer. Documents are moved one at a time using the ADF transporter into contact with a portion 147 of the support surface 144 of the transparent platen 145 corresponding to a parking position of the scan assembly 150. Light is emitted from light source 156 through the transparent platen 145 to reflect off the portion of the document in contact with the portion 147 of the transparent platen 145. Reflected light is received in photosensor array 152 and converted into electrical signals. The electrical signals are sent to the controller 170 for providing digitized data corresponding to the portion of the document. The document continues to advance past the parking position of the scan assembly in a direction away from transparent platen 145. As new portions of the document are brought into contact with first portion 147 of transparent platen 145, they are successively imaged, scan line by scan line. Finally the document is advanced to the output tray 184. For the case of a stack of documents, each document is loaded such that a side to be scanned for each document in the stack is facing toward the surface of the input tray 182. The steps for scanning a single document are repeated for each document in the stack.

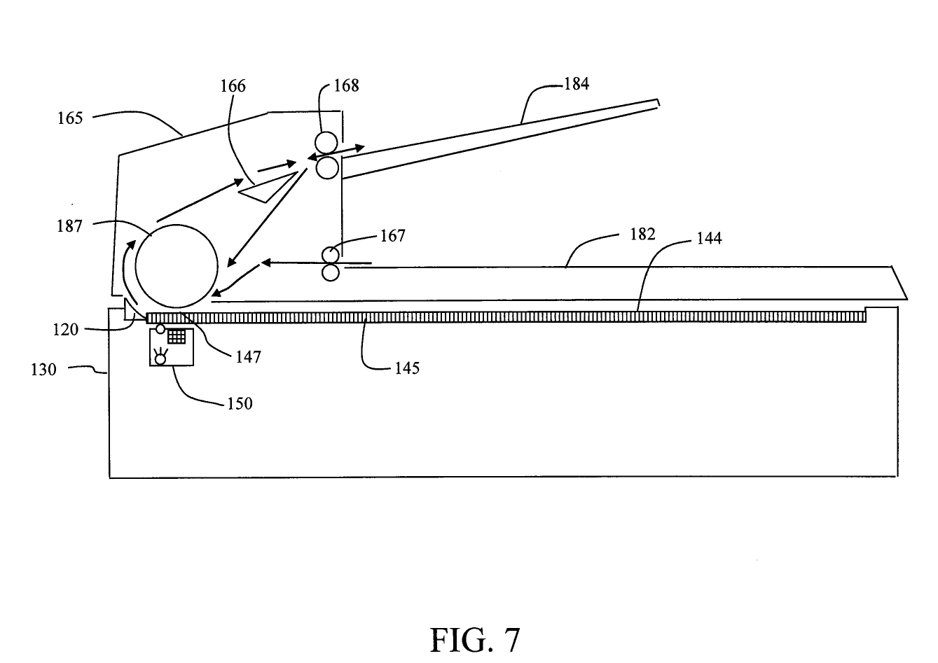

Some embodiments of the invention are equipped with a duplexing ADF 165 for two sided scanning of documents as shown in the lateral cross-sectional view of FIG. 7. The document feed path is indicated by arrows. A document is fed in from input tray 182. In the example of FIG. 7, feed rollers 167 move the document toward large roller 187 and toward transparent platen 145. After scanning, the document is lifted from the transparent platen 145 by document lifting surface 120 and then continues to be moved around large roller 187. The document then is fed across an upper surface of duplexing guide 166. If single-sided scanning is selected, the document is ejected onto output tray 184 with the scanned side facing up and away from the output tray. If two-sided scanning is selected, after the document has moved toward the output tray 184, the duplexing rollers 168 are rotated in reverse to move the document across a lower surface of duplexing guide 166 and from there to the large roller 187 in order to scan the other side of the document repeating the steps described above for scanning the first side.

Ignoring the duplexing functions shown in FIG. 7, the cross-sectional view of FIG. 7 is also useful for comparing document movement by rotational movement of large roller 187 in embodiments of the present invention relative to the large roller 74 in the prior art shown in FIG. 3. In particular in some embodiments of the invention having an ADF transporter including a large roller 187, a lead edge of the document is rotationally advanced by the large roller by an angular amount of less than 120 degrees (approximately 90 degrees in the example of FIG. 7) before the lead edge of the document is in contact with the portion 147 of the support surface 144 of the transparent platen 145. By comparison, in the prior art of FIG. 3, the lead edge of the document is rotationally advanced by large roller 74 by approximately 180 degrees before the lead edge of the document is in contact with platen glass 40.

In addition, with reference to FIG. 7 (and ignoring the duplexing functions), in some embodiments of the invention having an ADF transporter including a large roller 187, a lead edge of the document is rotationally advanced by the large roller 187 by an angular amount of less than 180 degrees (approximately 125 degrees in the example of FIG. 7) before the lead edge of the document is in contact with the document lifting surface 120. By comparison, in the prior art of FIG. 3, the lead edge of the document is rotationally advanced by the large roller 74 by an angular amount by approximately 195 degrees before the lead edge of the document is in contact with pickup unit 76.

The invention has been described in detail with particular reference to certain preferred embodiments thereof, but it will be understood that variations and modifications can be effected within the spirit and scope of the invention.

### PARTS LIST

33 Automatic document feeder (prior art)
36 Opening above reading window (prior art)
40 Platen glass (prior art)
41 Book platen glass (prior art)
62 Original feed tray (prior art)
63 Discharge tray (prior art)
70 Paper feed roller (prior art)
71 Separation roller (prior art)
72 Separation pad (prior art)
73 Convey rod (prior art)
74 Large roller (prior art)
75 Convey rod (prior art)
76 Pickup unit (prior art)
77 Discharge unit (prior art)
79 End detection sensor (prior art)
100 Multifunction printer (with automatic document feeder)
111 Under side of automatic document feeder
112 Hinge
114 Pressing plate
120 Document lifting surface
122 Recessed portion (of document lifting surface)
124 Protruding portion (of document lifting surface)
126 Document downward guide
130 Scanning apparatus
132 Scanning apparatus body
134 Scanning guide
135 Scanning direction
136 Frame
137 Down ramp
138 Up ramp
139 Spacer
140 Transparent platen
142 ADF transparent platen
143 Line
144 Support surface (of transparent platen)
145 Transparent platen (continuous member)
146 Opposite surface (of transparent platen)
147 First portion (of transparent platen)
148 Second portion (of transparent platen)
149 Edge (of transparent platen)
150 Scan assembly
152 Photosensor array
154 Bearing surface (of scan assembly)
156 Light source
160 Control panel
162 Display
164 Control buttons
165 Duplexing ADF
166 Duplexing guide
167 Feed rollers
168 Duplex rollers
170 Controller
171 Host computer
172 Memory
174 Power source
176 Motor (for sensor array)
178 Motor (for automatic document feeder)
180 Automatic document feeder
181 ADF document scan path (prior art)
182 Input tray
183 ADF document scan path
184 Output tray
185 Rotation direction
186 Document feed rollers
187 Large roller
188 Pressing member
190 Printing apparatus

1. A scanning apparatus comprising:
a scan assembly including a photosensor array for receiving light reflected from successive portions of an item and for converting the reflected light into electrical signals;
a transparent platen formed of a single continuous transparent member including:
a first surface for supporting an item to be scanned;
a second surface disposed opposite the first surface and proximate the scan assembly;
a first portion disposed proximate an edge of the transparent platen and corresponding to a parking position of the scan assembly; and
a second portion corresponding to a moving region of the scan assembly; and
an automatic document feeder for moving a document into contact with the first surface of the first portion of the transparent platen.

2. The scanning apparatus of claim 1 further comprising a document lifting surface disposed proximate the edge of the transparent platen.

3. The scanning apparatus of claim 2, wherein the document lifting surface is disposed beyond the edge of the transparent platen.

4. The scanning apparatus of claim 1, wherein a first portion of the document lifting surface is offset from the first surface of the transparent platen in a direction having a component that is along a direction from the first surface toward the second surface of the transparent platen, and wherein a second portion of the document lifting surface is offset from the first surface of the transparent platen in a direction having a component that is along a direction from the second surface toward the first surface of the transparent platen.

5. The scanning apparatus of claim 2 further comprising a frame for holding the transparent platen, wherein the document lifting surface is incorporated into the frame.

6. A scanning apparatus comprising:
a transparent platen including a first surface for supporting an item to be scanned and a second surface disposed opposite the first surface;
a light source configured to emit light through the transparent platen to reflect off the item;
a scan assembly disposed proximate the second surface of the transparent platen, the scan assembly including a photosensor array for receiving light reflected from successive portions of the item and for converting the reflected light into electrical signals;
a controller for providing digitized data from the electrical signals to form a digitized image of the item; and
an automatic document feeder including:
an input tray for loading documents to be scanned;
a transporter for moving a document into contact with a portion of the first surface of the transparent platen corresponding to a parking position of the scan assembly; and
an output tray for receiving documents after scanning, wherein the input tray is disposed between the output tray and the transparent platen.

7. The scanning apparatus of claim 6 further comprising a document lifting surface configured to guide a document away from contact with the transparent platen, wherein the transporter is disposed between the input tray and the document lifting surface.

8. The scanning apparatus of claim 7, wherein a first portion of the document lifting surface is offset from the first surface of the transparent platen in a direction having a component that is along a direction from the first surface toward the second surface of the transparent platen, and wherein a second portion of the document lifting surface is offset from the first surface of the transparent platen in a direction having a component that is along a direction from the second surface toward the first surface of the transparent platen.

9. The scanning apparatus of claim 6, the transporter comprising a roller including a rotation direction, wherein the scanning apparatus further comprises a document lifting surface configured to guide a document away from contact with the transparent platen, wherein the rotation direction of the roller is configured to move a document into contact with the portion of the transparent platen and then into contact with the document lifting surface.

10. The scanning apparatus of claim 9, wherein a first portion of the document lifting surface is offset from the first surface of the transparent platen in a direction having a component that is along a direction from the first surface toward the second surface of the transparent platen, and wherein a second portion of the document lifting surface is offset from the first surface of the transparent platen in a direction having a component that is along a direction from the second surface toward the first surface of the transparent platen.

11. The scanning apparatus of claim 6, the transparent platen including an extended portion for placing an item to be scanned as the scan assembly moves, wherein the extended portion of the transparent platen and the portion of the transparent platen corresponding to the parking position of the scan assembly are both parts of a single continuous transparent member.

12. The scanning apparatus of claim 6 further comprising a duplexer for scanning a first side and then a second side of the document.

13. A multifunction printer including:
a printing apparatus; and
a scanning apparatus comprising:
a scan assembly including a photosensor array for receiving light reflected from successive portions of an item and for converting the reflected light into electrical signals;
a transparent platen formed of a single continuous transparent member including:
a first surface for supporting an item to be scanned;
a second surface disposed opposite the first surface and proximate the scan assembly;
a first portion disposed proximate an edge of the transparent platen and corresponding to a parking position of the scan assembly; and
a second portion corresponding to a moving region of the scan assembly; and
an automatic document feeder for moving a document into contact with the first surface of the first portion of the transparent platen.

14. The multifunction printer of claim 13, wherein the scanning apparatus further comprises a document lifting surface disposed proximate the edge of the transparent platen.

15. A method of scanning a document on a scanning apparatus including:
a transparent platen including a first surface for supporting an item to be scanned and a second surface disposed opposite the first surface;
a light source;
a scan assembly disposed proximate the second surface of the transparent platen, the scan assembly including a photosensor array;
a controller; and
an automatic document feeder including:
an input tray;
a transporter; and
an output tray, wherein the input tray is disposed between the output tray and the transparent platen;
wherein the method comprises the steps:
a) loading a document onto a surface of the input tray with a side to be scanned facing the surface of the input tray;
b) initiating a scan operation;
c) moving the document using the transporter into contact with a portion of the first surface of the transparent platen corresponding to a parking position of the scan assembly;
d) emitting light from the light source through the transparent platen to reflect off the document;
e) receiving light reflected from a portion of the document in the photosensor array and converting the reflected light into electrical signals;
f) sending the electrical signals to the controller for providing digitized data corresponding to the portion of the document;
g) continuing to advance the document past the parking position of the scan assembly;
h) repeating steps d) through g) until the entire document has been scanned; and
i) advancing the document to the output tray.

16. The method according to claim 15, the document being a first document in a stack of documents, wherein the step of loading a document further comprises loading the stack of documents such that a side to be scanned for each document in the stack is facing toward the surface of the input tray; and wherein steps c) through i) are repeated for each document in the stack.

17. The method according to claim 15, the transporter being a roller, wherein a lead edge of the document is rotationally advanced by the roller an angular amount of less than 120 degrees before the lead edge is in contact with the portion of the first surface of the transparent platen.

18. The method according to claim 17, the scanning apparatus further including a document lifting surface disposed proximate the portion of the first surface of the transparent platen, wherein the lead edge of the document is rotationally advanced by the roller by an angular amount of less than 180 degrees before the lead edge is in contact with the document lifting surface.

19. The method according to claim 15, the scanning apparatus further including a duplexer, the side to be scanned in step a) being a first side to be scanned, the method further comprising:
using the duplexer to reverse the side of the document to the second side after steps c) through h) are completed for the first side of the document; and
repeating steps c) through h) for the second side of the document.
